(19) United States
(12) Patent Application Publication
(10) Pub. No.: US 2004/0009695 A1
(43) Pub. Date: Jan. 15, 2004

(54) CPU socket having reliable cam actuation device

(76) Inventors: Hui Ye, Kunsan (CN); Ren-Chih Li, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/364,893

(22) Filed: Feb. 11, 2003

(30) Foreign Application Priority Data
Jul. 10, 2002 (TW) 91210504

(51) Int. Cl. H01R 4/50

(52) U.S. Cl. 439/342

(57) ABSTRACT

A central processing unit (CPU) socket includes: a base (1) receiving contacts (2) therein; a cover (3) movably mounted on the base; and an actuation device (4) including a camshaft (41) rotatably engaged between the base and the cover, and a handle (42). The base defines a transverse first channel (12) at one end thereof, the first channel receiving the camshaft therein. A pin (43) extends coaxially from a free end of the camshaft. A recess (131) is defined in a sidewall (13) formed on the base at one end of the first channel. The pin is rotatably received in the recess. Accordingly, when the actuation device is rotated to drive the cover to slide relative to the base, a rotational axis of the camshaft is prevented from being displaced upwardly. Thus the camshaft does not disturb the cover, and correct engagement between the cover and the base is maintained.

### BACKGROUND OF THE INVENTION

1. Field of the Invention

The present invention relates to a CPU socket for electrically connecting an electronic package such as a central processing unit (CPU) with a circuit substrate such as a printed circuit board (PCB), and particularly to a CPU socket having a lever type cam actuation device.

2. Description of the Prior Art

CPU sockets are widely used in personal computer (PC) systems to electrically connect CPUs with PCBs. Referring to FIGS. 5 and 6, a conventional CPU socket comprises a base 9, a cover 7 movably mounted on the base 9, and an actuation device 6. The base 9 defines a multiplicity of vertical passageways 91 therethrough, the passageways 91 receiving a corresponding number of contacts 8 therein. The actuation device 6 comprises a camshaft 61 rotatably engaged between the base 9 and the cover 7, and a handle 62 extending perpendicularly from one end of the camshaft 61 and exposed outside the base 9. The base 9 also defines a transverse first channel 92 at one end thereof, the first channel 92 partly receiving the camshaft 61. The cover 7 defines a transverse second channel 71, the second channel 71 receiving a remaining part of the camshaft 61 that is exposed out of the first channel 92. A pair of latches 72 depends from an end wall of the cover 7 adjacent the second channel 71. The latches 72 engage with a protruding edge portion 93 of the base 9 that is near the first channel 92. The actuation device 6 is rotated to drive the cover 7 to slide relative to the base 9.

FIG. 7 illustrates a problem when operating the above-described conventional CPU socket. When the camshaft 61 is rotated, a free end of the camshaft 61 is liable to be upwardly displaced. Said free end forces the cover 7 upwardly, and warps the cover 7. The resulting improper positions of said free end and the cover 7 are represented by broken lines in FIG. 7. This can diminish precise engagement between the cover 7 and the base 9. In addition, during rotation of the camshaft 61, friction occurs between the latches 72 of the cover 7 and the protruding edge portion 93 of the base 9. This causes unwanted abrasion and noise. Furthermore, damage to the CPU socket may result.

In view of the above, a new CPU socket that overcomes the above-mentioned disadvantages is desired.

### SUMMARY OF THE INVENTION

Accordingly, an object of the present invention is to provide an electrical connector for electrically connecting an electronic package such as a CPU with a circuit substrate such as a PCB, whereby the electrical connector has a stable and reliable cam actuation device.

To achieve the above-mentioned object, a CPU socket in accordance with a preferred embodiment of the present invention comprises: a base defining a multiplicity of vertical passageways therethrough receiving a corresponding number of contacts therein; a cover movably mounted on the base; and an actuation device comprising a camshaft rotatably engaged between the base and the cover, and a handle extending substantially perpendicularly from one end of the camshaft and exposed outside the base. The base also defines a transverse first channel at one end thereof, the first channel receiving the camshaft therein. A pin extends coaxially from an opposite end of the camshaft. A recess is defined in a sidewall formed on the base at one end of the first channel, the recess being in communication with the first channel. The pin is rotatably received in the recess. Accordingly, when the actuation device is rotated to drive the cover to slide relative to the base, a rotational axis of the camshaft is prevented from being displaced upwardly. Thus the camshaft does not disturb the cover, and correct engagement between the cover and the base is maintained.

Other objects, advantages and novel features of the invention will become more apparent from the following detailed description when taken in conjunction with the accompanying drawings, in which:

### BRIEF DESCRIPTION OF THE DRAWINGS

FIG. 1 is a simplified, exploded isometric view of a CPU socket in accordance with the preferred embodiment of the present invention;

FIG. 2 is a partly assembled view of FIG. 1;

FIG. 3 is an enlarged, cross-sectional view taken along line III-III of FIG. 2;

FIG. 4 is similar to FIG. 3, but showing configuration in accordance with an alternative embodiment of the present invention;

FIG. 5 is a simplified, exploded isometric view of a conventional CPU socket;

FIG. 6 is an assembled view of FIG. 5; and

FIG. 7 is an enlarged, cross-sectional view taken along line VII-VII of FIG. 6, with improper positions of certain components being represented by broken

### DETAILED DESCRIPTION OF THE PREFERRED EMBODIMENTS OF THE INVENTION

Reference will now be made to the drawings to describe the present invention in detail.

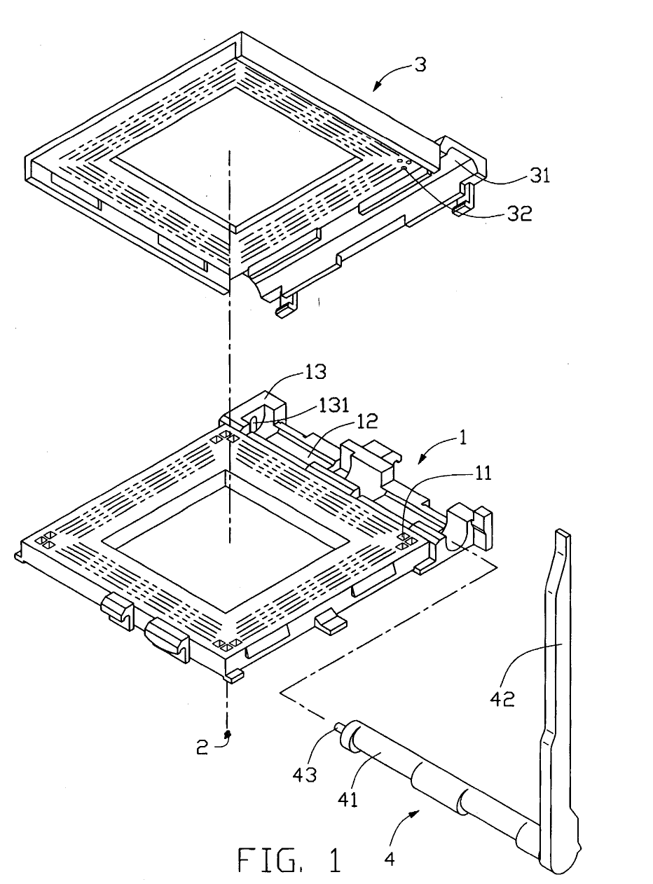

Referring to FIG. 1, a CPU socket in accordance with the preferred embodiment of the present invention comprises a flat insulative base 1, a cover 3 movably mounted on the base 1, and an actuation device 4 rotatably engaged between the base 1 and the cover 3.

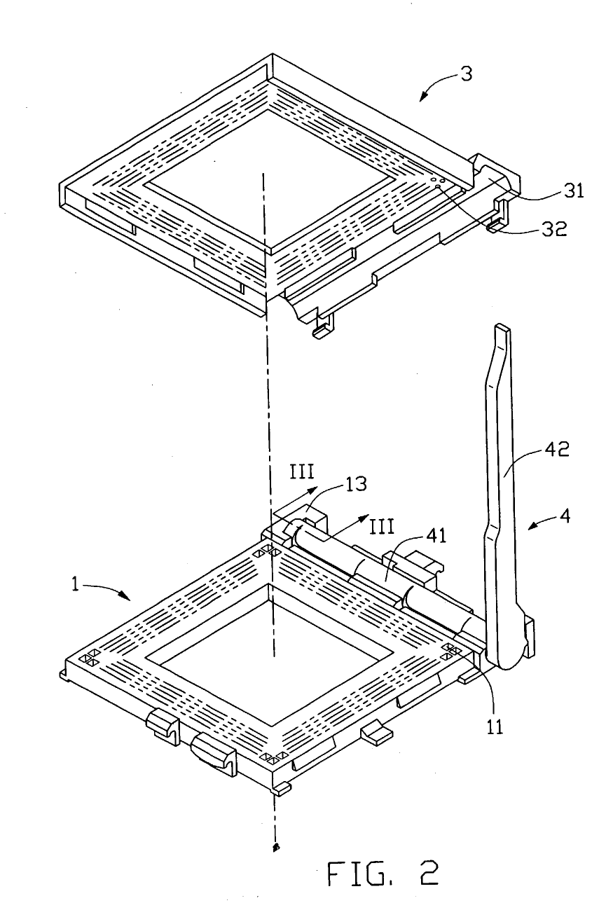

Also referring to FIGS. 2 and 3, the base 1 defines a multiplicity of vertical passageways 11 therethrough for receiving a corresponding number of contacts 2 therein. The base 1 also defines a transverse first channel 12 at one end thereof. A sidewall 13 is formed at one end of the first channel 12. A recess 131 is defined in the sidewall 13, in communication with the first channel 12.

The cover 3 defines a multiplicity of holes 32 therein, corresponding to the passageways 11 of the base 1. A second transverse channel 31 is defined in one end of the cover 3, corresponding to the first channel 12 of the base 1.

The actuation device 4 comprises a camshaft 41 rotatably engaged between the base 1 and the cover 3, and a handle 42 extending perpendicularly from one end of the camshaft 41 and exposed outside the base 1. A pin 43 extends coaxially from an opposite end of the camshaft 41.

Referring to FIG. 2, in assembly, the first channel 12 of the base 1 partly receives the camshaft 41 of the actuation device 4 therein, and the second channel 31 of the cover 3 receives a remaining part of the camshaft 41 which is exposed out of the first channel 12. At the same time, the pin 43 of the camshaft 41 is rotatably received in the recess 131 of the base 1. Accordingly, when the actuation device 4 is rotated to drive the cover 3 to slide relative to the base 1, a rotational axis of the camshaft 41 is prevented from being displaced upwardly. Thus the camshaft 41 does not disturb the cover 3, and correct engagement between the cover 3 and the base 1 is maintained.

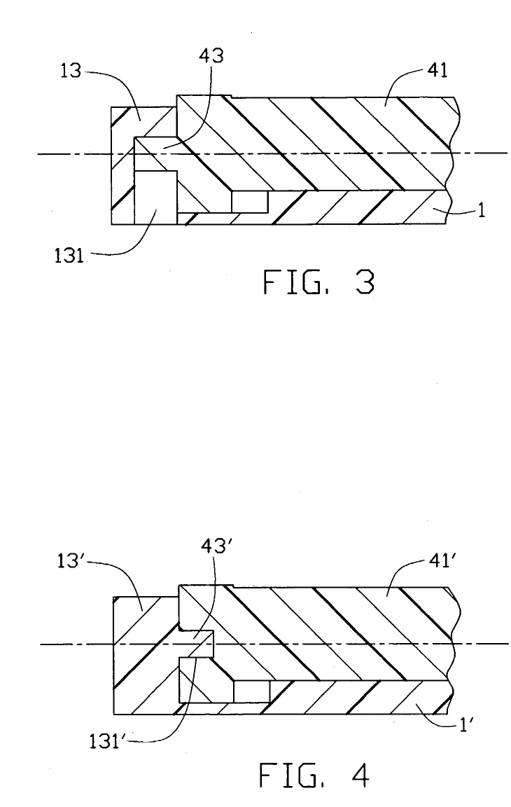

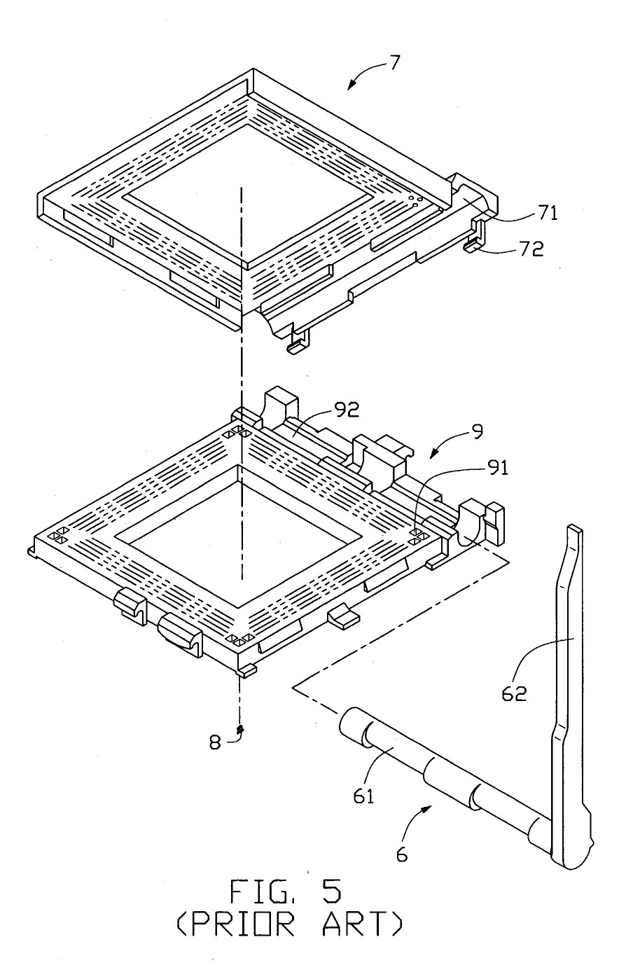

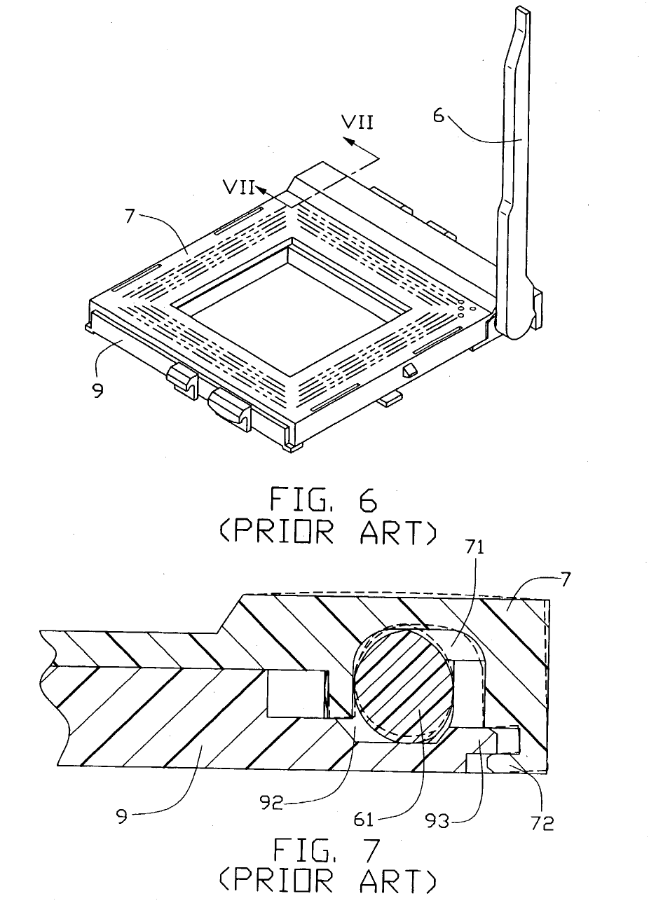

Referring to FIG. 4, a CPU socket in accordance with the alternative embodiment of the present invention has a configuration similar to that of the preferred embodiment. However, in the alternative embodiment, a recess 131′ is defined in a free end of a camshaft 41′. A pin 43′ is formed on an inside of a sidewall 13′ of a base 1′, the pin 43′ being rotatably received in the recess 131′. Thus a rotational axis of the camshaft 41′ is prevented from being displaced upwardly.

While preferred embodiments in accordance with the present invention en shown and described, equivalent modifications and changes known to skilled in the art according to the spirit of the present invention are red within the scope of the present invention as defined in the appended

We claim:

1. An electrical connector for electrically connecting an electronic package with a circuit substrate, the electrical connector comprising:
a base defining a plurality of passageways therethrough, and a transverse first channel in an end thereof, a sidewall formed at an end of the first channel, the sidewall defining a recess therein;
a plurality of contacts received in the passageways;
a cover movably mounted on the base;
an actuation device rotatably engaged between the cover and the base, the actuation device comprising a camshaft pivotably received in the first channel of the base, and a handle extending substantially perpendicularly from the camshaft, the camshaft having a distal end;
wherein a pivot is arranged at the distal end of the camshaft, and the pivot is pivotably received in the recess of the base.

2. The electrical connector as claimed in claim 1, wherein the cover defines a transverse second channel in one end thereof corresponding to the first channel of the base, the second channel pivotably receiving the camshaft.

3. The electrical connector as claimed in claim 1, wherein the pivot is a pin.

4. An electrical connector for electrically connecting an electronic package with a circuit substrate, the electrical connector comprising:
a base defining a plurality of passageways therethrough and a transverse first channel in an end thereof, a sidewall formed at an end of the first channel, the sidewall having a pivot arranged thereat;
a plurality of contacts received in the passageways;
a cover movably mounted on the base;
an actuation device rotatably engaged between the cover and the base, the actuation device comprising a camshaft pivotably received in the first channel of the base, and a handle extending substantially perpendicularly from the camshaft;
wherein a recess is defined in a distal end of the camshaft, and the pivot of the base is pivotably received in the recess.

5. The electrical connector as claimed in claim 4, wherein the cover defines a transverse second channel in one end thereof corresponding to the first channel of the base, the second channel pivotably receiving the camshaft.

6. The electrical connector as claimed in claim 4, wherein the pivot is a pin.

7. An electrical connector comprising:
a stationary base defining a plurality of vertical passageways and on a rear portion a transverse channel with an end wall thereof;
a plurality of contacts respectively received in the corresponding passageways;
a moveable cover mounted on the base and defining a plurality of through holes in alignment with the corresponding passageways, respectively;
an actuation device including:
a cam shaft rotatably received in said transverse channel and hidden under the cover so as to actuate the cover to move relative to the base during rotation of the cam shaft; and
a handle perpendicularly extending from one end of the cam shaft for rotating the cam shaft; wherein
the other end of said cam shaft is rotatably engaged with the end wall so as to prevent upward movement of said other end when said handle is downwardly moved from a vertical position to a horizontal position.

8. The connector as claimed in claim 7, wherein a pivot is coaxially formed on said other end of the cam shaft to be received in a recess in the end wall.

9. The connector as claimed in claim 7, wherein a pivot is formed on the end wall and is received in a recess in said other end, said recess being coaxial with said cam shaft.
